(19) United States
(12) Patent Application Publication
(10) Pub. No.: US 2008/0170342 A1
(43) Pub. Date: Jul. 17, 2008

(54) Multistage series circuit system

(75) Inventor: Nobuyoshi Osamura, Nishio-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/902,670

(22) Filed: Sep. 25, 2007

(30) Foreign Application Priority Data
Jan. 11, 2007 (JP) 2007-3369
Jun. 26, 2007 (JP) 2007-167595

(51) Int. Cl. H02H 9/04

(52) U.S. Cl. 361/56

(57) ABSTRACT

A multistage series circuit system includes: multiple DC power sources coupled in series with each other; multiple unit circuits coupled in parallel with a power source; multiple first protection circuits for protecting each unit circuit; and a second protection circuit for protecting the whole system. Each first protection circuit is coupled in parallel with the unit circuit. The second protection circuit is coupled in parallel with the whole system. Each protection circuit functions to reduce a positive excess voltage when the positive excess voltage is applied to the unit circuit or the whole system. Each protection circuit functions to flow a current along with a voltage applying direction of a negative excess voltage when the negative excess voltage is applied to the unit circuit or the whole system.

### CROSS REFERENCE TO RELATED APPLICATIONS

This application is based on Japanese Patent Applications No. 2007-3369 filed on Jan. 11, 2007, and No. 2007-167595 filed on Jun. 26, 2007, the disclosures of which are incorporated herein by reference.

### FIELD OF THE INVENTION

The present invention relates to a multistage series circuit system.

### BACKGROUND OF THE INVENTION

A multistage series circuit system includes multiple DC power supplies and multiple unit circuits. The DC power supplies are coupled in series with each other. Each unit circuit is connected in parallel with a corresponding DC power supply.

A lithium battery as a secondary battery (i.e., a rechargeable battery) generates a voltage about four volts. Multiple lithium batteries are connected in series with each other so that a desired voltage of a power source is obtained. It is necessary for the lithium battery to monitor a charging state and a discharging state of the battery and to control avoiding excess charge and excess discharge. Accordingly, a control circuit is connected to each unit. Further, a protection circuit is connected to each control circuit so that the protection circuit protects the control circuit from a surge voltage applied to the control circuit.

The inventor raises a problem about the multistage series circuit system. That is how to protect each control circuit and how to protect the whole system in which multiple control circuits are connected in series with each other.

FIG. 5 shows a multistage series circuit system 5 as a related art. The system 5 includes multiple DC power sources 1(1)-1(n), multiple control circuits 2(1)-2(n), and multiple protection circuits 3(1)-3(n). Each power source 1(1)-1(n) is connected in parallel with a control circuits 2(1)-2(n) and a protection circuits 3(1)-3(n). The protection circuit 3(1)-3(n) is formed by a Zener diode having a Zener voltage Vz of 40 volts. A clamp voltage VA is 40 volts when a positive surge voltage is applied to system 5. The clamp voltage VB is 0.7 volts when a positive surge voltage is applied to system 5.

When the number of series stages is eight (i.e., n=8) and the eighth terminal V8 is a reference terminal, the clamp voltage V2C(+) of the second terminal V2 is defined as follows when the positive surge voltage is applied to the second terminal V2.

V2C(+)=VA2+VA3+VA4+VA5+VA6+VA7=240 Volts

When a negative surge voltage is applied to the second terminal V2, the clamp voltage V2C(−) of the second terminal V2 is defined as follows.

V2C(−)=−VB2−VB3−VB4−VB5−VB6−VB7=−4.2 Volts

When the number of series stages is eight (i.e., n=8) and the third terminal V3 is a reference terminal, the clamp voltage V7C(+) of the seventh terminal V7 is defined as follows when the positive surge voltage is applied to the seventh terminal V7.

V7C(+)=VB3+VB4+VB5+VB6=2.8 Volts

When a negative surge voltage is applied to the seventh terminal V7, the clamp voltage V7C(−) of the seventh terminal V7 is defined as follows.

V7C(−)=−VA3−VA4−VA5−VA6=−160 Volts

In the above cases, each control circuit 2(1)-2(8) is appropriately protected. However, when the eighth terminal V8 is the reference terminal, a voltage difference between the second terminal V2 and the eighth terminal V8 is 240 Volts. When the third terminal V3 is the reference terminal, a voltage difference between the seventh terminal V7 and the third terminal V3 is −160 Volts. Accordingly, the voltage difference may exceed a breakdown voltage of an insulation film, which is disposed between wiring layers so that the insulation film is broken down. If a distance between adjacent wirings in the same wiring layer is comparatively small, insulation between the adjacent wirings may be also broken down.

Thus, it is required for a multistage series circuit system to protect each unit circuit individually and to protect the whole system.

### SUMMARY OF THE INVENTION

In view of the above-described problem, it is an object of the present disclosure to provide a multistage series circuit system.

According to a first aspect of the present disclosure, a multistage series circuit system includes: a plurality of DC power sources, which are coupled in series with each other; a plurality of unit circuits, each of which is coupled in parallel with a corresponding DC power source; a plurality of first protection circuits for protecting each unit circuit; and a second protection circuit for protecting the whole system. Each first protection circuit is coupled in parallel with a corresponding unit circuit. Each first protection circuit functions to reduce a positive excess voltage when the positive excess voltage is applied to the unit circuit. Each first protection circuit functions to flow a current along with a voltage applying direction of a negative excess voltage when the negative excess voltage is applied to the unit circuit. The second protection circuit is coupled in parallel with the whole system. The second protection circuit functions to reduce a positive excess voltage when the positive excess voltage is applied to the whole system. The second protection circuit functions to flow a current along with a voltage applying direction of a negative excess voltage when the negative excess voltage is applied to the whole system.

In the above system, each unit circuit is individually protected, and the whole system, i.e., the whole unit circuits, is also protected.

According to a second aspect of the present disclosure, a multistage series circuit system includes: a plurality of DC power sources, which are coupled in series with each other; a plurality of unit circuits, each of which is coupled in parallel with a corresponding DC power source; a plurality of first protection circuits for protecting each unit circuit; and a second protection circuit for protecting a part of the plurality of unit circuits, which are coupled in series with each other through corresponding DC power sources. Each first protection circuit is coupled in parallel with a corresponding unit circuit. Each first protection circuit functions to reduce a positive excess voltage when the positive excess voltage is applied to the unit circuit. Each first protection circuit functions to flow a current along with a voltage applying direction of a negative excess voltage when the negative excess voltage is applied to the unit circuit. The second protection circuit is coupled in parallel with the part of the plurality of unit circuits. The second protection circuit functions to reduce a positive excess voltage when the positive excess voltage is applied to the part of the plurality of unit circuits. The second protection circuit functions to flow a current along with a voltage applying direction of a negative excess voltage when the negative excess voltage is applied to the part of the plurality of unit circuits.

In the above system, each unit circuit is individually protected, and the whole system, i.e., the whole unit circuits, is also protected.

According to a third aspect of the present disclosure, a multistage series circuit system includes: a plurality of DC power source, which are coupled in series with each other; a plurality of unit circuits, each of which is coupled in parallel with a corresponding DC power source; and a plurality of protection circuits for protecting each unit circuit and the whole system. Each protection circuit is coupled between a positive side terminal of a corresponding DC power supply and a minimum reference potential terminal of the plurality of DC power sources. Each protection circuit functions to reduce a positive excess voltage when the positive excess voltage is applied to the unit circuit. Each protection circuit functions to flow a current along with a voltage applying direction of a negative excess voltage when the negative excess voltage is applied to the unit circuit.

In the above system, the construction of the system is simplified. Further, each unit circuit is individually protected, and the whole system, i.e., the part of the whole unit circuits, is also protected.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a multistage series circuit system according to a first embodiment of the present disclosure;

FIG. 2 is a circuit diagram showing a protection circuit in the system;

FIG. 3 is a block diagram showing a multistage series circuit system according to a second embodiment of the present disclosure;

FIG. 4 is a block diagram showing a multistage series circuit system according to a third embodiment of the present disclosure; and

FIG. 5 is a block diagram showing a multistage series circuit system according to a related art.

### DETAILED DESCRIPTION OF THE PREFERRED EMBODIMENTS

### First Embodiment

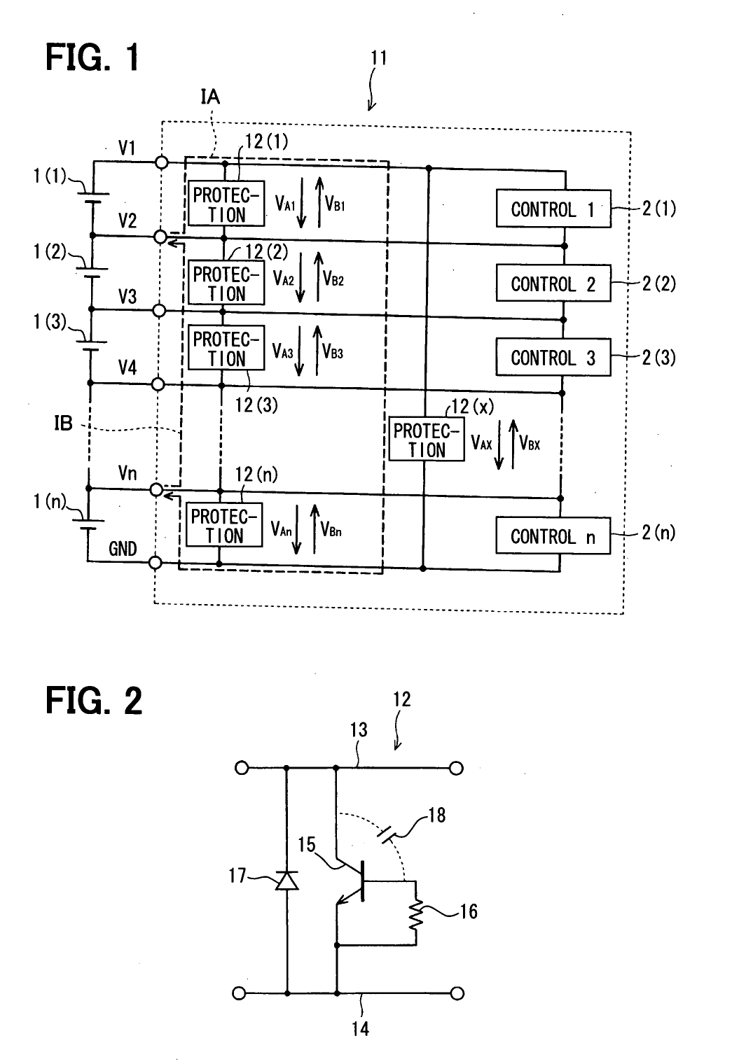

FIG. 1 shows a multistage series circuit system 11 having multiple DC power supplies 1(1)-1(n), multiple unit circuits 2(1)-2(n), i.e., multiple control circuits, and multiple protection circuits 12(1)-12(n). Here, VA1 to VAn represent positive surge clamp voltages, and VB1 to VBn represent negative surge clamp voltages. IA represents a loop for positive surge protection, and IB represents a loop (or a route) for negative surge protection. The system 11 further includes an additional protection circuit 12(x) as a whole circuit protection circuit, which is disposed between the first terminal V1 and the ground GND. Each protection circuit 12(1)-12(n) functions as an individual circuit protection circuit.

FIG. 2 shows one of the individual circuit protection circuits 12(1)-12(n) and the whole circuit protection circuit 12(x). The protection circuit 12 includes a NPN transistor 15, a resistor 16 and a diode 17. The NPN transistor 15 has a collector connecting to a high potential side power source line 13 and an emitter connecting to a low potential side power source line 14. The resistor 16 is connected between a base of the transistor 15 and the low potential side power source line 14. The diode 17 is inversely connected between the high potential side power source line 13 and the low potential side power source line 14. In the protection circuit 12, a parasitic capacitance 18 is formed between the collector and the base of the transistor 15. Accordingly, when a spike voltage is applied to the high potential side power source line 13, a base current flows into the transistor 15 through the parasitic capacitance 18, so that the transistor 15 turns on, i.e., conducts. Although the protection circuit 12 includes the diode 17, the diode 17 may be provided by a parasitic element.

Assuming that the number of series stages is eight (i.e., n=8), functions of the system are explained as follows. Here, the clamp voltage VA is 40 Volts when a positive surge voltage is applied to the protection circuit 12. Practically, the clamp voltage is provided by a collector-emitter voltage VCE of the transistor 15, and therefore, the clamp voltage may become smaller. The clamp voltage VB is 0.7 Volts when a negative surge voltage is applied to the protection circuit 12.

When the eighth terminal V8 is a reference terminal and the positive surge voltage is applied to the second terminal V2, the clamp voltage V2C(+) of the second terminal V2 is defined as follows.

V2C(+)=VB1+VAx+VB8=41.4 Volts

When the negative surge voltage is applied to the second terminal V2, the clamp voltage V2C(−) of the second terminal V2 is defined as follows.

V2C(−)=−VB2−VB3−VB4−VB5−VB6−VB7=−4.2 Volts

When the third terminal V3 is the reference terminal, and the positive surge voltage is applied to the seventh terminal V7, the clamp voltage V7C(+) of the seventh terminal V7 is defined as follows.

V7C(+)=VB3+VB4+VB5+VB6=2.8 Volts

When the negative surge voltage is applied to the seventh terminal V7, the clamp voltage V7C(−) of the seventh terminal V7 is defined as follows.

V7C(−)=−VB7−VB8−VAx−VB1−VB2=−42.8 Volts

In the above system 11, the individual circuit protection circuits 12(1)-12(n) are connected in parallel to the control circuits 2(1)-2(n), respectively. In addition, the whole circuit protection circuit 12(x) is connected in parallel to the whole multistage series circuit. Thus, when the positive surge voltage is applied to the system, the whole circuit protection circuit 12(x) provides protection of the system. Further, when the negative surge voltage is applied to the system, the whole circuit protection circuit 12(x) provides protection of the system. Accordingly, a potential difference generated in case of protection operation is much reduced. Thus, individual protection of each control circuit 2(1)-2(n) and whole protection of series construction of the control circuits 2(1)-2(n) are sufficiently performed.

Since each protection circuit 12 is composed of the transistor 15, the resistor 16 and the diode 17, excess voltage is reduced to the collector-emitter voltage VCE when a spike voltage is applied to the high potential side power source line 13 and the transistor 15 conducts through the parasitic capacitor 18 between the collector and the base. Thus, the protection operation is performed in accordance with a steep waveform of the surge voltage.

### Second Embodiment

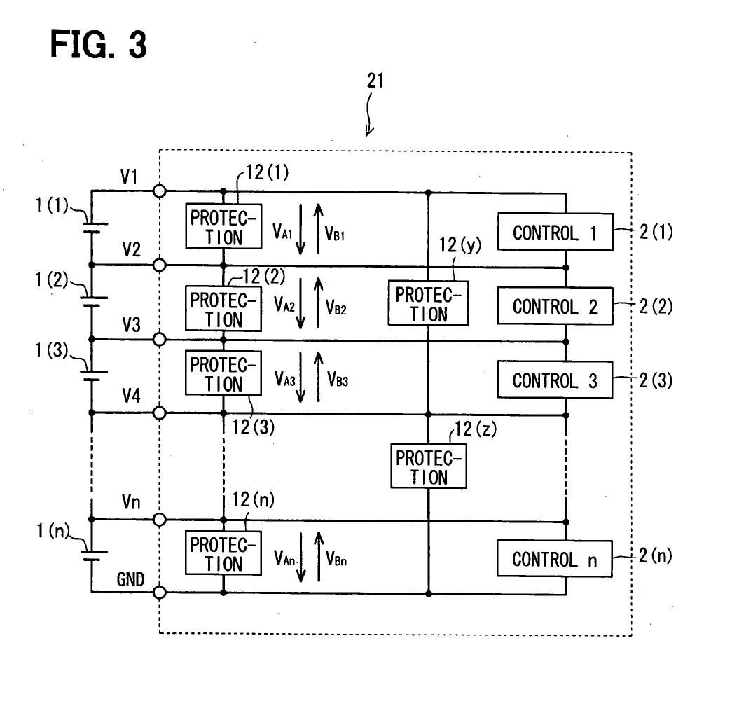

FIG. 3 shows a multistage series circuit system 21 according to a second embodiment of the present disclosure. The system 21 includes a pair of group protection circuits 12(y), 12(z). The first group protection circuit 12(y) is disposed between the first terminal V1 and the fourth terminal V4, and the second group protection circuit 12(z) is disposed between the fourth terminal V4 and the ground GND. Here, the control circuits 12(1)-12(3) provide a first series group, and the control circuits 12(4)-12(n) provide a second series group.

When a surge voltage is applied to one of the terminals V1-V4, the first group protection circuit 12(y) functions as a protection circuit in the first series group. When a surge voltage is applied to one of the terminals V4-GND, the second group protection circuit 12(z) functions as a protection circuit in the second series group. Further, when a surge voltage is applied to one of the terminals V1-V4 and another surge voltage is applied to one of the terminals V4-GND, both of the first and second group protection circuits 12(y), 12(z) function as a protection circuit.

Accordingly, if a surge voltage is often applied between specific terminals, a group protection circuit is formed between the specific terminals so that effective protection is served.

### Third Embodiment

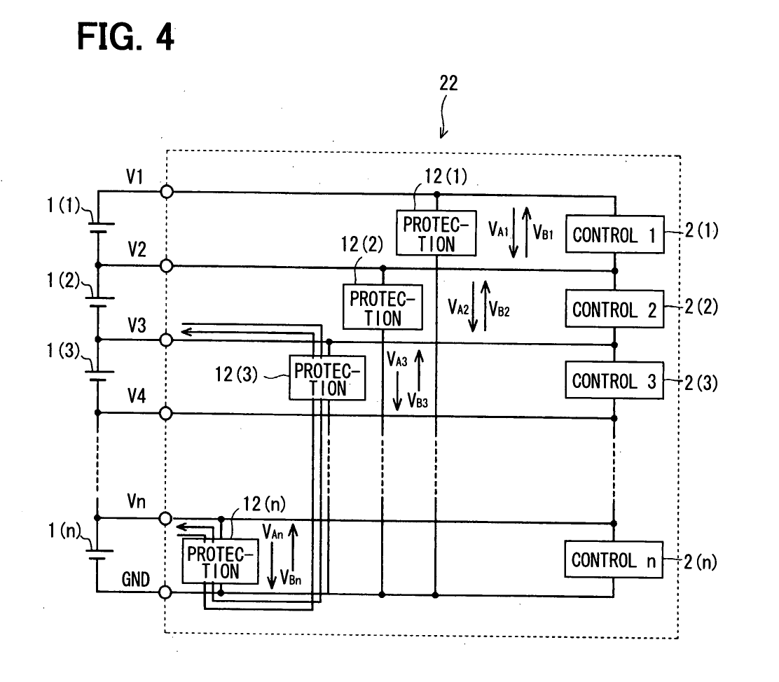

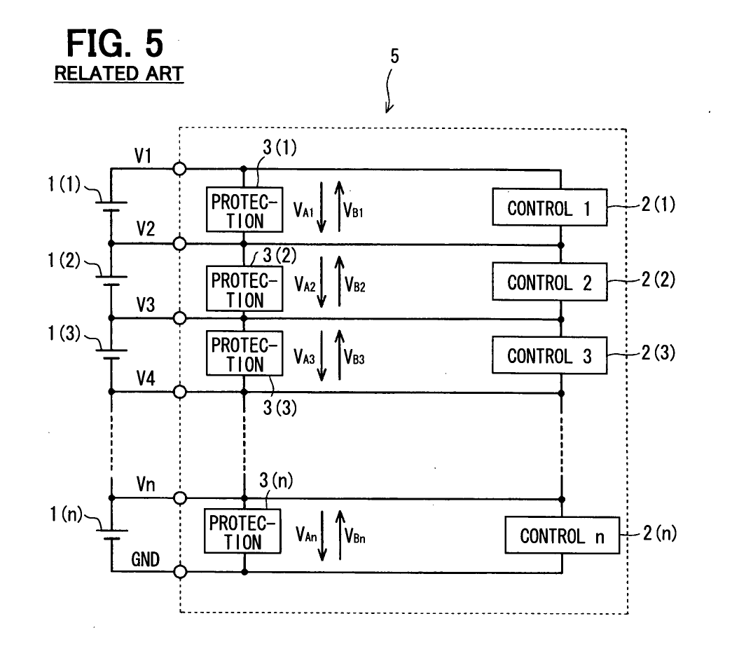

FIG. 4 shows a multistage series circuit system 22 according to a third embodiment of the present disclosure. In the system 22, a negative side terminal of each protection circuit 12(1)-12(n) is connected to a negative side terminal of the power source 1(n), i.e., the ground GND. Specifically, the protection circuit 12(1)-12(n) is not connected in parallel to the control circuit 2(1)-2(n).

When a positive surge voltage is applied between the first terminal V1 and the ground GND, the clamp voltage is defined as VA1, and when a negative surge voltage is applied between the first terminal V1 and the ground GND, the clamp voltage is defined as VB1. When the positive surge voltage is applied between two terminals other than the first terminal V1 and the ground GND, the clamp voltage is defined as VAx+VBx, and when the negative surge voltage is applied between two terminals other than the first terminal V1 and the ground GND, the clamp voltage is also defined as VAx+VBx. For example, when the positive surge voltage is applied between the third terminal V3 and the n-th terminal Vn, the clamp voltage is defined as VA3+VBn. When the negative surge voltage is applied between the third terminal V3 and the n-th terminal Vn, the clamp voltage is defined as VAn+VB3.

In this system, each protection circuit 12 is not connected in parallel to the control circuit 2. When the surge voltage is applied between both ends of each control circuit 2, the clamp voltage slightly increases. However, the number of protection circuits 12 is equal to the number of the control circuits 2, and therefore, the construction of the system is simplified.

### Modifications

Although the protection circuit 12 includes the diode 17, the protection circuit 12 may include a Zener diode. Alternatively, the protection circuit 12 may include a Zener diode, a resistor and a transistor.

Although the first group protection circuit 12(y) is the same circuit as the second group protection circuit 12(z), the first group protection circuit 12(y) may be different from the second group protection circuit 12(z). Although the system 21 includes two group protection circuits 12(y), 12(z), the system 21 may include only one group protection circuit. Further, the first group protection circuit 12(y) may overlap with the second group protection circuit 12(z).

Although the system 11, 21, 22 controls charge and discharge of the lithium battery, the system 11, 21, 22 may control energy supply to multiple unit circuits, which are connected in parallel to multiple DC power sources, respectively, and the DC power sources is connected in series with each other.

The above disclosure has the following aspects.

According to a first aspect of the present disclosure, a multistage series circuit system includes: a plurality of DC power sources, which are coupled in series with each other; a plurality of unit circuits, each of which is coupled in parallel with a corresponding DC power source; a plurality of first protection circuits for protecting each unit circuit; and a second protection circuit for protecting the whole system. Each first protection circuit is coupled in parallel with a corresponding unit circuit. Each first protection circuit functions to reduce a positive excess voltage when the positive excess voltage is applied to the unit circuit. Each first protection circuit functions to flow a current along with a voltage applying direction of a negative excess voltage when the negative excess voltage is applied to the unit circuit. The second protection circuit is coupled in parallel with the whole system. The second protection circuit functions to reduce a positive excess voltage when the positive excess voltage is applied to the whole system. The second protection circuit functions to flow a current along with a voltage applying direction of a negative excess voltage when the negative excess voltage is applied to the whole system.

A clamp voltage of each protection circuit is defined as VA when a positive surge voltage is applied to the system, and a clamp voltage of each protection circuit is defined as VB when a negative surge voltage is applied to the system. The second protection circuit is connected between a positive terminal V(+) and a negative terminal V(−).

When a low potential side terminal VL between the positive terminal V(+) and the negative terminal V(−) is a reference terminal, a protection route is described as follows in a case where the positive surge voltage is applied to the high potential side terminal VH.

VH→(the first protection circuit)Xα→V(+)→(the second protection circuit)→V(−)→(the first protection circuit)Xβ→VL

Here, α represents the number of multiple stages between the terminal VH and the terminal V(+), and β represents the number of multiple stages between the terminal V(−) and the terminal VL. Accordingly, the potential difference VC1(+) generated in the protection circuit is VC1(+)=VB X(α+β)+VA.

The clamp voltage VA is only provided by a voltage generated through the second protection circuit. Accordingly, a clamp voltage of whole system is reduced. Further, when the negative surge voltage is applied between the terminals, the clamp voltage of whole system is described as (−VB X γ). Here, γ represents the number of multiple stages between the terminal VL and the terminal VH.

When the terminal VH is a reference terminal, and the positive surge voltage is applied to the terminal VL, the clamp voltage of whole system is described as (−VB X γ). When the negative surge voltage is applied to the system, the protection route is described as follows.

VL→(the first protection circuit)Xβ→V(−)→(the second protection circuit)→V(+)→(the first protection circuit)Xα→VH

Accordingly, the potential difference VC2(−) generated in the protection circuit is VC2(−)=−VB X (α+β)−VA.

Thus, the clamp voltage of the whole system is also reduced.

Thus, in either case, the protection route is formed through the second protection circuit, so that the potential difference generated in a case where the protection operation is performed is much reduced. Thus, each unit circuit is individually protected, and the whole system, i.e., the whole unit circuits, is also protected.

Alternatively, each of the first protection circuit may include a first transistor, a first resistor and a first diode. The first protection circuit is coupled in parallel with the corresponding unit circuit through a first high potential side wire and a first low potential side wire. The first transistor has a collector connecting to the first high potential side wire, an emitter connecting to the first low potential side wire, and a base connecting to the first low potential side wire through the first resistor therebetween. The first diode is reversely coupled between the first high potential side wire and the first low potential side wire. The second protection circuit includes a second transistor, a second resistor and a second diode. The second protection circuit is coupled in parallel with the whole system through a second high potential side wire and a second low potential side wire. The second transistor has a collector connecting to the second high potential side wire, an emitter connecting to the second low potential side wire, and a base connecting to the second low potential side wire through the second resistor therebetween. The second diode is reversely coupled between the second high potential side wire and the second low potential side wire.

According to a second aspect of the present disclosure, a multistage series circuit system includes: a plurality of DC power sources, which are coupled in series with each other; a plurality of unit circuits, each of which is coupled in parallel with a corresponding DC power source; a plurality of first protection circuits for protecting each unit circuit; and a second protection circuit for protecting a part of the plurality of unit circuits, which are coupled in series with each other through corresponding DC power sources. Each first protection circuit is coupled in parallel with a corresponding unit circuit. Each first protection circuit functions to reduce a positive excess voltage when the positive excess voltage is applied to the unit circuit. Each first protection circuit functions to flow a current along with a voltage applying direction of a negative excess voltage when the negative excess voltage is applied to the unit circuit. The second protection circuit is coupled in parallel with the part of the plurality of unit circuits. The second protection circuit functions to reduce a positive excess voltage when the positive excess voltage is applied to the part of the plurality of unit circuits. The second protection circuit functions to flow a current along with a voltage applying direction of a negative excess voltage when the negative excess voltage is applied to the part of the plurality of unit circuits.

When the surge voltage is applied in the part of the plurality of unit circuits, the second protection circuit functions similar to the second protection circuit defined in the first aspect. Thus, the clamp voltage of the whole system is reduced.

Thus, each unit circuit is individually protected, and the whole system, i.e., the part of the whole unit circuits, is also protected.

According to a third aspect of the present disclosure, a multistage series circuit system includes: a plurality of DC power source, which are coupled in series with each other; a plurality of unit circuits, each of which is coupled in parallel with a corresponding DC power source; and a plurality of protection circuits for protecting each unit circuit and the whole system. Each protection circuit is coupled between a positive side terminal of a corresponding DC power supply and a minimum reference potential terminal of the plurality of DC power sources. Each protection circuit functions to reduce a positive excess voltage when the positive excess voltage is applied to the unit circuit. Each protection circuit functions to flow a current along with a voltage applying direction of a negative excess voltage when the negative excess voltage is applied to the unit circuit.

A clamp voltage of each protection circuit is defined as VA when the positive surge voltage is applied to the system, and a clamp voltage of each protection circuit is defined as VB when the negative surge voltage is applied to the system. When the positive surge voltage is applied to the terminal V(+), the clamp voltage of the whole system is described as VA, and when the negative surge voltage is applied to the terminal V(−), the clamp voltage of the whole system is described as VB. When the positive surge voltage is applied to another terminal other than the terminals V(+), V(−), the clamp voltage of the whole system is described as VA+VB, and when the negative surge voltage is applied to another terminal other than the terminals V(+), V(−), the clamp voltage of the whole system is described as VA+VB. Accordingly, although the clamp voltage of the whole system is slightly increased when the surge voltage is applied to both ends of each unit circuit, the number of protection circuits is the same as the number of unit circuits. Thus, the construction of the system is simplified. Further, each unit circuit is individually protected, and the whole system, i.e., the part of the whole unit circuits, is also protected.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A multistage series circuit system comprising:
a plurality of DC power sources, which are coupled in series with each other;
a plurality of unit circuits, each of which is coupled in parallel with a corresponding DC power source;
a plurality of first protection circuits for protecting each unit circuit; and
a second protection circuit for protecting the whole system, wherein
each first protection circuit is coupled in parallel with a corresponding unit circuit,
each first protection circuit functions to reduce a positive excess voltage when the positive excess voltage is applied to the unit circuit,
each first protection circuit functions to flow a current along with a voltage applying direction of a negative excess voltage when the negative excess voltage is applied to the unit circuit,
the second protection circuit is coupled in parallel with the whole system,
the second protection circuit functions to reduce a positive excess voltage when the positive excess voltage is applied to the whole system, and
the second protection circuit functions to flow a current along with a voltage applying direction of a negative excess voltage when the negative excess voltage is applied to the whole system.

2. The system according to claim 1, wherein
each of the first protection circuit includes a first transistor, a first resistor and a first diode,
the first protection circuit is coupled in parallel with the corresponding unit circuit through a first high potential side wire and a first low potential side wire,
the first transistor has a collector connecting to the first high potential side wire, an emitter connecting to the first low potential side wire, and a base connecting to the first low potential side wire through the first resistor therebetween,
the first diode is reversely coupled between the first high potential side wire and the first low potential side wire,
the second protection circuit includes a second transistor, a second resistor and a second diode,
the second protection circuit is coupled in parallel with the whole system through a second high potential side wire and a second low potential side wire,
the second transistor has a collector connecting to the second high potential side wire, an emitter connecting to the second low potential side wire, and a base connecting to the second low potential side wire through the second resistor therebetween, and
the second diode is reversely coupled between the second high potential side wire and the second low potential side wire.

3. The system according to claim 2, wherein
each unit circuit is coupled in parallel with the corresponding DC power source through the first high potential side wire and the first low potential side wire,
the second high potential side wire corresponds to a maximum potential of the system, and
the second low potential side wire corresponds to a minimum potential of the system.

4. The system according,to claim 3, wherein
the minimum potential is a ground potential,
each DC power source is a secondary battery, and
each unit circuit is a control circuit for monitoring and controlling the corresponding DC power source to avoid excess charging and excess discharging of the DC power source.

5. The system according to claim 4, wherein
the plurality of DC power sources includes a maximum potential side DC power source and a minimum potential side DC power source,
the first high potential side wire of the maximum potential side DC power source provides the second high potential side wire, and
the first low potential side wire of the minimum potential side DC power source provides the second low potential side wire.

6. A multistage series circuit system comprising:
a plurality of DC power sources, which are coupled in series with each other;
a plurality of unit circuits, each of which is coupled in parallel with a corresponding DC power source;
a plurality of first protection circuits for protecting each unit circuit; and
a second protection circuit for protecting a part of the plurality of unit circuits, which are coupled in series with each other through corresponding DC power sources, wherein
each first protection circuit is coupled in parallel with a corresponding unit circuit,
each first protection circuit functions to reduce a positive excess voltage when the positive excess voltage is applied to the unit circuit,
each first protection circuit functions to flow a current along with a voltage applying direction of a negative excess voltage when the negative excess voltage is applied to the unit circuit,
the second protection circuit is coupled in parallel with the part of the plurality of unit circuits,
the second protection circuit functions to reduce a positive excess voltage when the positive excess voltage is applied to the part of the plurality of unit circuits, and
the second protection circuit functions to flow a current along with a voltage applying direction of a negative excess voltage when the negative excess voltage is applied to the part of the plurality of unit circuits.

7. The system according to claim 6, wherein
each of the first protection circuits includes a first transistor, a first resistor and a first diode,
the first protection circuit is coupled in parallel with the corresponding unit circuit through a first high potential side wire and a first low potential side wire,
the first transistor has a collector connecting to the first high potential side wire, an emitter connecting to the first low potential side wire, and a base connecting to the first low potential side wire through the first resistor therebetween,
the first diode is reversely coupled between the first high potential side wire and the first low potential side wire,
the second protection circuit includes a second transistor, a second resistor and a second diode,
the second protection circuit is coupled in parallel with the part of the plurality of unit circuits through a second high potential side wire and a second low potential side wire,
the second transistor has a collector connecting to the second high potential side wire, an emitter connecting to the second low potential side wire, and a base connecting to the second low potential side wire through the second resistor therebetween, and
the second diode is reversely coupled between the second high potential side wire and the second low potential side wire.

8. The system according to claim 7, wherein
each unit circuit is coupled in parallel with the corresponding DC power source through the first high potential side wire and the first low potential side wire,
the second high potential side wire corresponds to a maximum potential of the part of the plurality of unit circuits, and
the second low potential side wire corresponds to a minimum potential of the part of the plurality of unit circuits.

9. The system according to claim 8, wherein
each DC power source is a secondary battery, and
each unit circuit is a control circuit for monitoring and controlling the corresponding DC power source to avoid excess charging and excess discharging of the DC power source.

10. The system according to claim 9, wherein
the part of the plurality of DC power sources includes a maximum potential side DC power source and a minimum potential side DC power source,
the first high potential side wire of the maximum potential side DC power source provides the second high potential side wire, and
the first low potential side wire of the minimum potential side DC power source provides the second low potential side wire.

11. A multistage series circuit system comprising:
a plurality of DC power source, which are coupled in series with each other;
a plurality of unit circuits, each of which is coupled in parallel with a corresponding DC power source; and
a plurality of protection circuits for protecting each unit circuit and the whole system, wherein
each protection circuit is coupled between a positive side terminal of a corresponding DC power supply and a minimum reference potential terminal of the plurality of DC power sources,
each protection circuit functions to reduce a positive excess voltage when the positive excess voltage is applied to the unit circuit, and
each protection circuit functions to flow a current along with a voltage applying direction of a negative excess voltage when the negative excess voltage is applied to the unit circuit.

12. The system according to claim 11, wherein
each protection circuit includes a transistor, a resistor and a diode,
the transistor has a collector connecting to the positive side terminal, an emitter connecting to the minimum reference potential terminal, and a base connecting to the minimum reference potential terminal through the resistor therebetween, and
the diode is reversely coupled between the positive side terminal and the minimum reference potential terminal.

13. The system according to claim 12, wherein
each unit circuit is coupled in parallel with the corresponding DC power source through a high potential side wire and a low potential side wire, and
the high potential side wire is coupled with the positive side terminal of the corresponding DC power supply.

14. The system according to claim 13, wherein
the minimum reference potential terminal is a ground potential terminal,
each DC power source is a secondary battery, and
each unit circuit is a control circuit for monitoring and controlling the corresponding DC power source to avoid excess charging and excess discharging of the DC power source.

15. The system according to claim 14, wherein
the plurality of DC power sources includes a maximum potential side DC power source and a minimum potential side DC power source, and
the low potential side wire of the minimum potential side DC power source is coupled with the minimum reference potential terminal.
